(19) United States
(12) Patent Application Publication
(10) Pub. No.: US 2025/0127677 A1
(43) Pub. Date: Apr. 24, 2025

(54) TECHNOLOGY-ASSISTED WALKER FOR IMPROVING WALKER FUNCTIONALITY

(71) Applicant: George Kirkman, Palos Verdes Estates, CA (US)

(72) Inventors: Brianna Adewinmbi, Torrance, CA (US); Colin Adreani, Los Angeles, CA (US); Sarah Arata, Rancho Palos Verdes, CA (US); Samantha Chang, Rancho Palos Verdes, CA (US); Nolan Cheng, Pasadena, CA (US); Abigail Chiang, Rancho Palos Verdes, CA (US); BING JIANG, PALOS VERDES ESTATE, CA (US); George Kirkman, Palos Verdes Estates, CA (US); Matthew Kwon, Rancho Palos Verdes, CA (US); Avery Lam, Torrance, CA (US); Sean Magers, Torrance, CA (US); Kate North, Rolling Hills Estates, CA (US); Andres Perez, Torrance, CA (US); Matthew Rosenbaum, Palos Verdes Estates, CA (US); Justin Sato, Torrance, CA (US); Samuel Socol, Rancho Palos Verdes, CA (US); Leo Tampkins, Inglewood, CA (US); Alexander Werth, Los Angeles, CA (US); Veronica Yeh, Rancho Palos Verdes, CA (US)

(73) Assignee: Rolling Robots STEM Partners, Rolling Hills Estates, CA (US)

(21) Appl. No.: 18/732,813

(22) Filed: Jun. 4, 2024

Related U.S. Application Data
(60) Provisional application No. 63/507,940, filed on Jun. 13, 2023.

(51) Int. Cl. A61H 3/04

(52) U.S. Cl. CPC A61H 3/04; A61H 2003/043; A61H 2003/046; A61H 2201/5097

(57) ABSTRACT

The device belongs to the field of assistive walking devices, particularly those with integrated electronics and software. This walker addresses the problem of high fall risk among elderly adults, specifically the increased risk from slippery surfaces and having the walker out of reach. To mitigate the walker being out of reach from the user, it has a unique Summon feature, which incorporates motors, software, and several sensors to enable the walker to self-navigate to the user. This feature can be activated via a button on a compatible wrist-wearable device on the user. To prevent falls on slippery surfaces the walker has an Autobrake, Compared to similar devices, this walker allows for increased convenience and safety from falls.

### TECHNICAL FIELD

The device relates to the field of mobility aids, more specifically to an electronically-enhanced walker that includes features such as a motor-driven autonomous summon feature, grip-pressure dependent automatic braking systems, a wearable locator beacon, and actuator-powered folding.

### BACKGROUND

Mobility aids such as walkers are commonly used by the frail and elderly to maintain their ability to move despite physical impediments. Walkers typically consist of a sturdy metal frame with two handles on the top for its user to grip for support, two to four wheels to decrease friction against the ground, and sometimes a seat that allows for use as a wheelchair when needed.

While the benefits provided by these walkers are certainly immense and they have allowed countless people to continue their lives unimpeded by physical disabilities, they still face a number of serious problems. Most critically is their inconvenience that, in many cases, discourages use, thus causing injury to befall their users. There are a variety of other concerns with walkers, such as the requirement of the elderly to exert unreasonable force to brake or fold the walker, or the obvious safety issue faced by elderly who are unable to reach their walkers.

### SUMMARY

The aforementioned problems of convenience and safety are solved by the invention, which consists of a metal frame that is open on the rear and has wheels on the bottom, a seat midway up the frame, and handlebars on the top extending out toward the rear. The wheels on the bottom consist of two swivel wheels on the front and two motorized standard wheels in the rear. The seat midway up the frame of the wheel chair is supported by triangular metal braces and has the circuitry, RF signal receivers, sensors, RF transmitters, and battery of the walker attached to its underbelly. The handles are outfitted with pressure sensors inside the grip to detect when the walker is being held or not. When the pressure sensors are released, they send a signal to the aforementioned circuitry at the base of the walker, which, in turn, sends a signal to the motorized wheels to begin proactively braking the walker. Additional electronic peripherals can also activate linear actuators to assist in the folding and unfolding of the walker. Alternatively, when the RF signal receivers get a signal from a wearable device to begin navigating towards its user, the sensors begin accumulating data of the surrounding environment to create a digital map which is then interpreted by a navigation algorithm to make a path, which is then carried out when signals are sent to the motors to move the walker towards the summoning device.

### BRIEF DESCRIPTION OF THE DRAWINGS

FIG. 1 shows the avionics block diagram.

FIG. 2 shows an isometric view of the walker device (upright, seat down) in accordance with the present invention.

FIG. 3 shows the side view of the same walker depicted in FIG. 2.

FIG. 4 shows the front view of the same walker depicted in FIG. 2.

FIG. 5 shows an isometric view of the walker device (folded) in accordance with the present invention.

FIG. 6 shows the side view of the same walker depicted in FIG. 6.

FIG. 7 shows the front view of the same walker depicted in FIG. 6.

FIG. 8 shows the linear actuator safety latch

FIG. 9 shows an isometric view of the handlebars folded down as well as the brake mechanism.

FIG. 10 shows an isometric view of the electronics tray.

FIG. 11 shows an isometric view of the RF Beacon Housing

FIG. 12 shows an image of the RF beacon Housing gain pattern and relative RSSI around the walker.

FIG. 13 shows the flow of logic and execution of the software in the form of a flowchart.

FIG. 14 shows the flow of logic and execution of the navigation algorithm in the form of a flowchart.

FIG. 15 shows a multiple views of the wearable

FIG. 16 shows the concept of operations in the form of a flowchart.

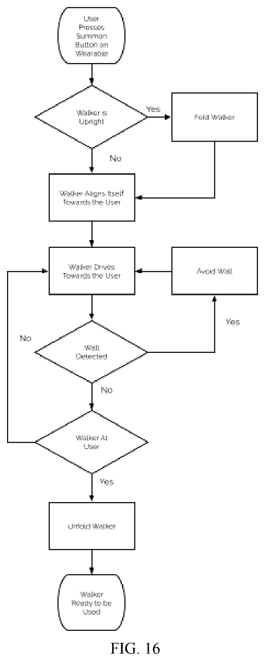

### DETAILED DESCRIPTION

In accordance with the present invention, a self-navigating and proactively braking walker is described, consisting of two front wheels which are free to swivel, two back motorized wheels which fixed in-line with the sides of the walker, a frame, a seat, circuitry, a RF receiver, a RF transmitter, sensors, a battery, handles, and pressure sensors.

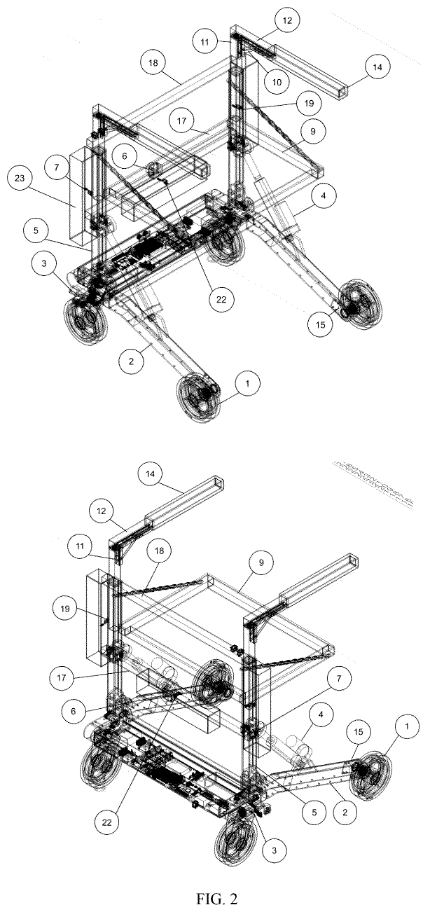

As seen in FIG. 2, the frame of the walker consists of attached beams with two lower beams horizontal to the ground on which the wheels are mounted, two beams (5) perpendicular to the ground that reach upwards from the horizontal beams, handlebars (12) facing the rear of the walker, and crossbars (17 and 18) where appropriate, particularly at the very top of the walker and at regular intervals throughout. As shown in 9, there is a seat supported by metal beams which attaches to the aforementioned perpendicular beam via a pin joint at the back of the seat and a chain at the front of the seat. As shown in 13, the base of the walker also has a metal compartment located underneath in which the majority of the walker's electronic components are housed.

All structural beams and other such components used in this device, such as the vertical beams pictured in 2, 5, and 11, are created from machined metal, bended sheet metal, or another such lightweight material. The previously mentioned vertical beams seen in 5 and 11 are roughly equal to each other in length and the same equivalency in length between pairs is also present in the horizontal beams, the seat's support beams, the side beams on the base, and the handlebars. The horizontal beams shown in 17 and 18 connect the vertical beams of the walker and provide a surface for the LiDAR (6) and switches to rest on. The side beams on the base, which can be seen in 2, support the linear actuator (4), motors (15), and wheel assemblies (1). Additionally, all of the aforementioned pairs of structural beams also roughly share diameter between members of the same pair.

All structural components are, as seen in FIG. 2, attached to each other through the use of screws, nuts, and bolts, all of which are made from metal such as stainless steel. As is standard with the usage of screws and bolts, a hole is machined through the material for the screw or bolt to go through, the screw or bolt is inserted through the hole, and is then locked into place and tightened on both sides against the aforementioned material by a nut having its external threads interlocked into the internal threads of the screw or not and rotated to the right until no longer possible.

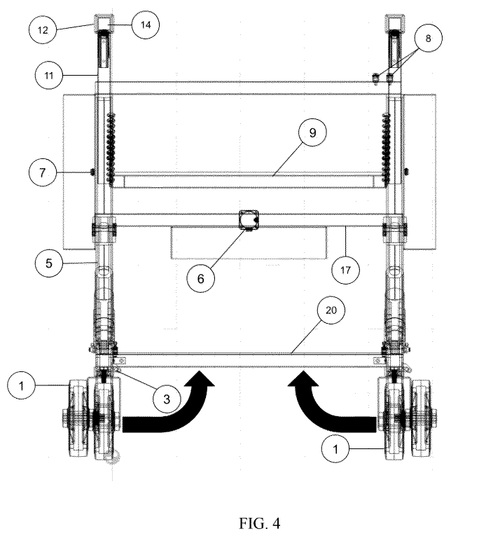

There are four wheels on the walker, depicted in 1. The back wheels are connected to a hinge, as shown in 3 (folding direction shown in FIG. 4), which serves to conserve space when the walker is in a folded position. The front wheels are connected to motors, depicted by 15, which are used when the walker is being summoned to the user.

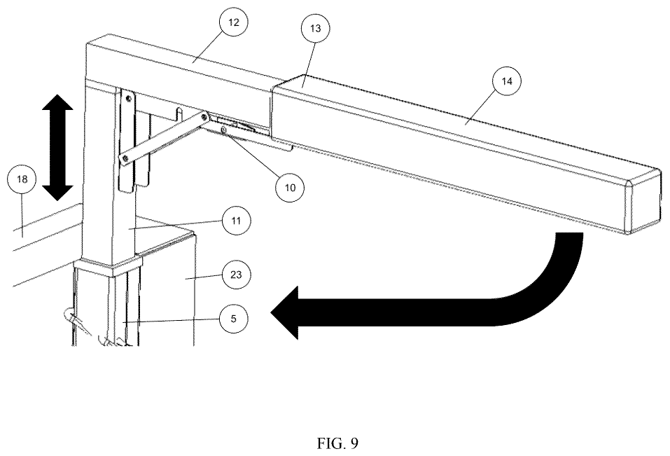

The previously mentioned handlebars, as seen in 12, are composed of hollow tubes with pressure sensors, as shown in 13, situated along the top of both handles. When the handlebars's pressure sensors are compressed, they send an analog electrical signal down the wires and into the circuitry housed below the seat. The walker's main computer is programmed to interpret that signal as the user gripping the walker, and, in response, send an electrical signal through the wires to the motorized wheels. This allows the wheels to release their active braking, thus unlocking the wheels, and allowing the walker to be used. When the pressure sensors are released, the signal stops and the walker resumes its active braking, locking itself in place. The handlebars are able to collapse and deploy via the hinge mechanism in 10 and as shown in FIG. 9. The hinge mechanism is manually operated, as the collapse functionality is toggled through the use of a protruding lever on the mechanism. In addition, there are grips on the handlebars as shown in 14 for more comfortable usage of the walker. The height of the handlebars can also be adjusted by moving the beam shown by 11 up or down.

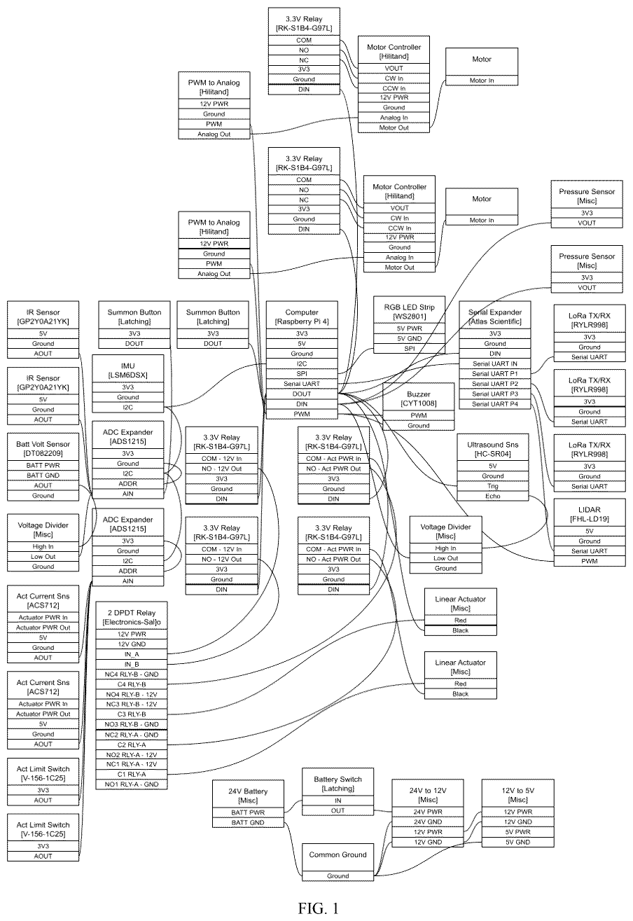

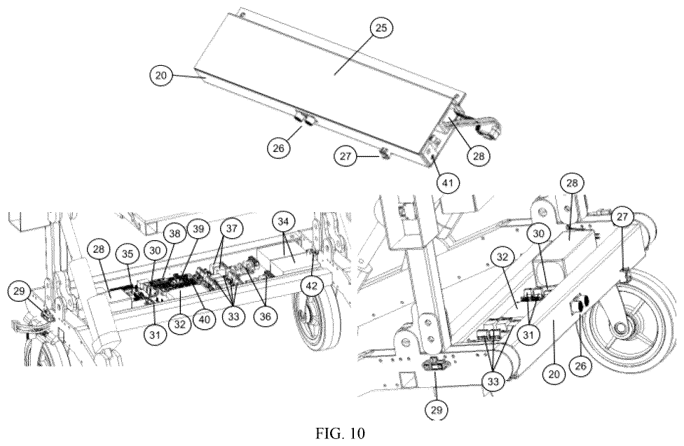

As shown primarily in FIG. 10, which is the primary view of the main electronics panel (20), the main electrical components on the walker include, but are not limited to, an ultrasonic sensor (26), a power switch (27), a battery (28), battery voltage sensor (30), a linear actuator current sensor (31), DPDT relays (32), SPST relays (33 and 37), motor speed controllers (34), a microcontroller (35), analog to PWM convertors (36), I2C to analog convertors (38), an accelerometer (39), a gyroscope (39), a noise emitting buzzer (40), and two voltage convertors (43). Additionally, the bottom of the sides of the walker feature IR sensors (29), which work in conjunction with the ultrasonic sensor to detect the presence of objects or walls in close proximity to the walker. The DPDT and SPST relays are used to control both the actuators and the motors, with their primary function being to control the direction in which the actuators move, and which direction the wheels spin. The motor speed controllers and the Analog to PWM converters regulate the motor speed. The I2C to analog converter serves to allow for a sufficient number of analog ports for the main computer to operate the ultrasonic sensors, current sensor, voltage sensors, gyroscope, and accelerometer. The aforementioned accelerometer and gyroscope are used to aid in the walker's motion, ensuring that it is able to know its current position and heading with great accuracy. The buzzer serves as a way to communicate to the user what state the walker is currently in. The states that the buzzer can be in include, but are not limited to, “off,” which plays no noise and is used for when the buzzer is not currently being used; “summon,” which pulses periodically to signify when the walker is navigating towards the user; “fold,” which plays a different type of pulse that signifies when the walker is folding up or down; and “reached destination,” which plays a preprogrammed short tune to signify when the walker has reached its position after navigating towards the user. All electronics are controlled by the main computer, and powered by the rechargeable onboard battery. Power from the battery can be disconnected or connected to the downstream loads (such as the aforementioned main computer, sensors, motors, and linear actuators) via the latching power switch. The various logic voltages required by different electronic components around the walker are regulated by the voltage converters, including but not limited to, a 24v to 12v step-down converter and a 12v to 5v step-down converter. The voltage sensor is used to monitor the battery's state of charge, while the current sensor monitors the force of the linear actuator. If the battery's voltage is detected to be too low, the user will be notified, and if the battery's charge is detected to be critically low, the walker will shut down immediately. If the current draw from the linear actuators is detected to be too high, then they will immediately stop moving. There is one limit switch on either side of the walker that triggers when the walker is in the upright position, and un-triggers when the walker is in its folded position (42). The full suite of electrical components and how each is connected to each other can be found in FIG. 1. The electronics tray as a whole is covered by a piece of bent sheet metal in the form as shown in 25. The electronics tray itself is also a piece of bent sheet metal and 41 shows the attachment points between the electronics tray and the frame of the walker.

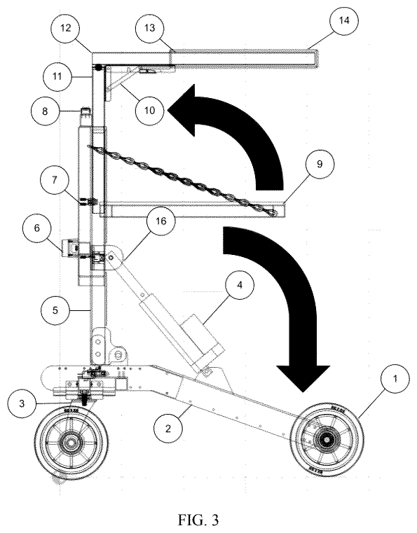

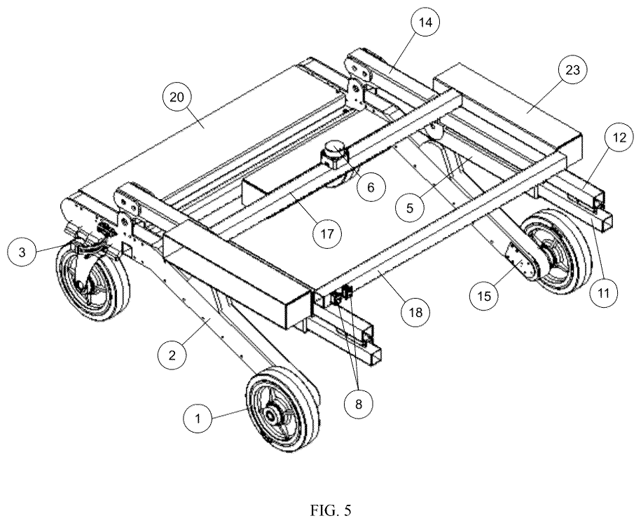

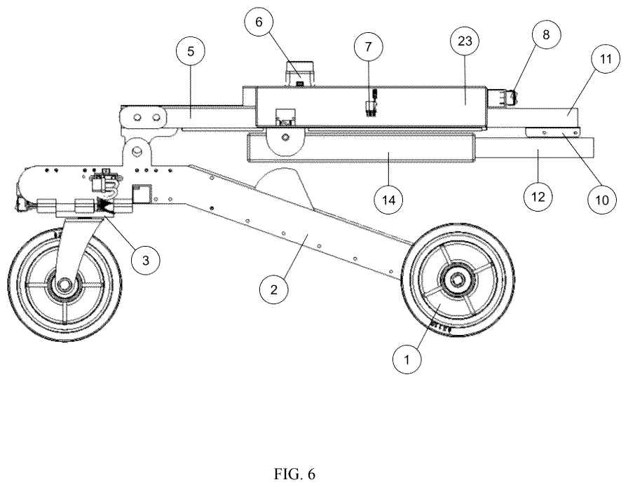

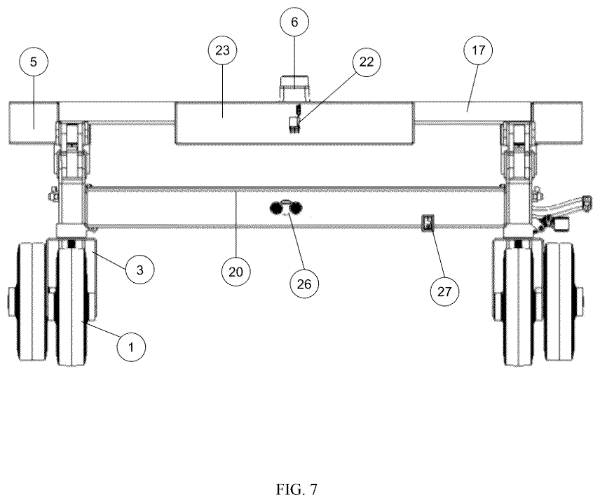

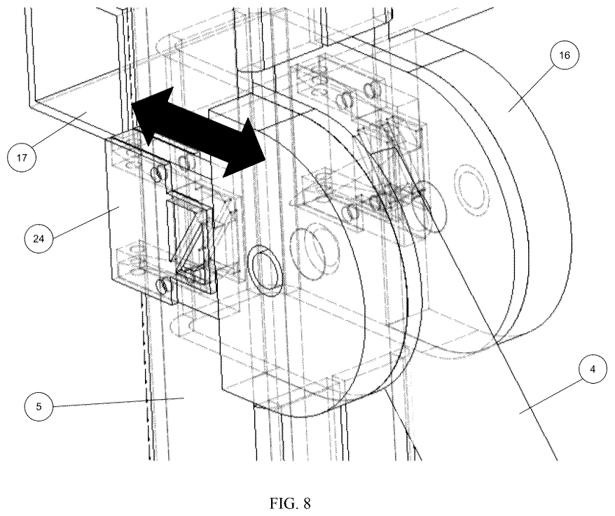

The previously mentioned circuitry located at the base of the walker, specified in 20, will also contain components used to activate the assisted folding and unfolding feature of the walker. When a user toggles this feature of the walker using, a linear actuator, as depicted in 4, will produce the required force to collapse and expand the walker without additional intervention from a human user. The linear actuator is attached to the walker via a joint, as shown in 16, which allows the walker to fold and expand. In FIG. 8, the linear actuator and components that allow the walker to collapse and expand can be clearly seen. The linear actuator (4) is attached to and pivots around a joint (16). This joint is connected to a spring loaded latch, as seen in 24. When the linear actuator is expanded or retracted, it moves the latch (24) up or down the vertical beam (5). If there is too much force on this spring, such as when the walker is collapsing on the user's hand or another body part, the latch mechanism detaches from the joint. This causes the linear actuator to detach from the vertical beam on the walker, which would prevent serious harm or injury to the user. The folding direction is shown in FIG. 3 and references of the walker in its folded state can be found in FIGS. 5, 6, and 7. The seat of the walker is able to be folded either upwards or downwards when the user wants their walker to be in the fully collapsed configuration. To activate the folding functionality, the user can press the switch located on the top horizontal beam, as seen in 8 or by pressing the appropriate button on the wearable (27).

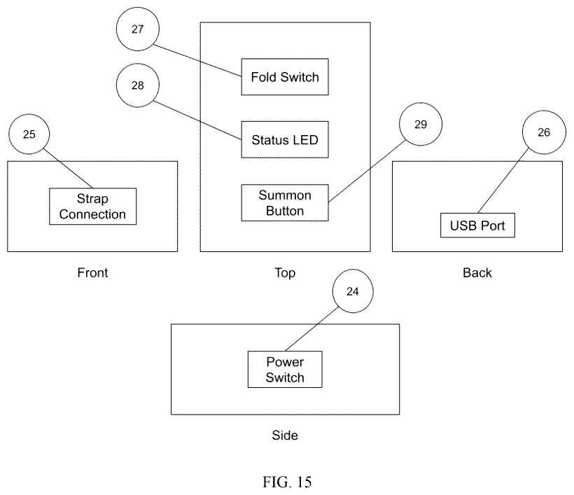

As shown in FIG. 15, the rechargeable wearable device sends RF signals to the walker, transmitting the user's relative location. At the push of a button on the wearable, the walker will make its way towards the user's position, only if the walker is in a folded configuration. If the walker is upright, then it will automatically fold downwards and commence navigation towards the user. When the main switch is toggled upwards, the walker will unfold. When toggled downwards, the walker will fold in on itself. The wearable is to be worn around the user's neck on a string. The power switch on the side is to be turned on before the device can function. 24 The power switch turns the device on and off. When on, all other aspects of this device will be functional. When turned off, the device will not function. 25 The strap connection is a loop, meant to have a string strung through it and tied to act as a necklace. This necklace would then be worn by the user, with the button facing away from the user's body. 26 The USB port allows the wearable device to be recharged. 27 The fold switch determines whether the walker is folded in on itself or unfolded. If the switch is toggled upwards, the walker will unfold. When toggled downwards, the walker will fold in on itself. 28 The status LED indicates whether the walker has been called. It will be turned on when the summon button (29) is pushed, and turned off when the walker has arrived at the user. 29 When pushed, the summon button will send RF signals to the walker, causing the walker to navigate to the user.

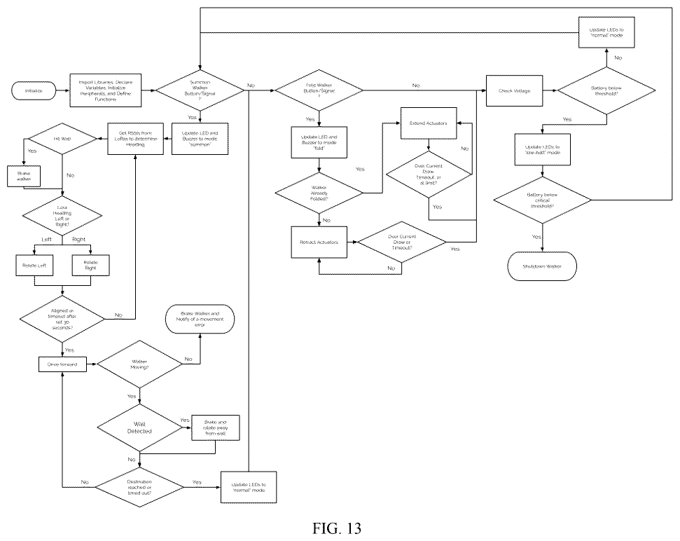

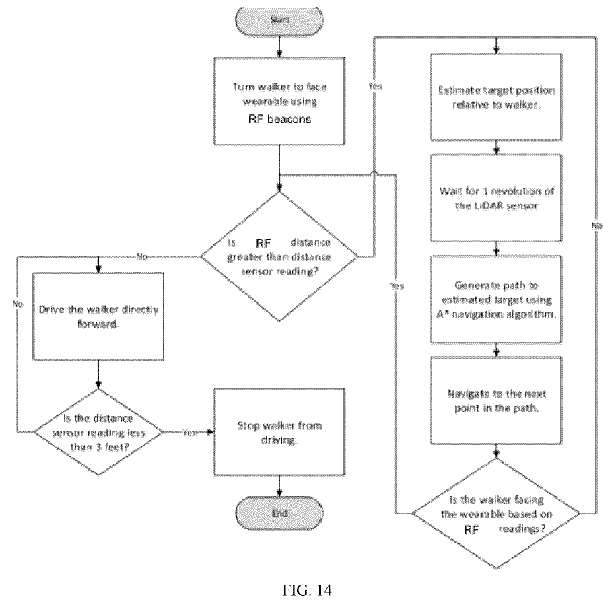

As seen in 7, 19, and 22, when a RF summoning signal is received by the RF receivers, it passes the signal to the circuitry, which then uses its software to interpret the signal as a summon request. The summoning feature can also be activated by pressing the switch located on the top horizontal beam of the walker, as depicted in 8. These receivers are housed in boxes, as seen in 23, located on the left, right, and back sides of the walker. From there, the navigation algorithm, as depicted in the form of a flowchart in FIG. 14, is initialized. This algorithm begins with a comparison between readings from three separate RF sensors to orient the walker towards the wearable device. Once oriented, the algorithm will run through a system of logic to decide whether to navigate using a path generated with the A* navigation algorithm or directly drive towards the wearable. If A* navigation is selected as the appropriate method of navigation, the algorithm will utilize inputs from a LiDAR sensor, as shown in 6, to outline obstacles and represent the walker's surroundings as an array of points. The output of this navigation algorithm is a course and motor-instructions which are sent down the wires to the motors themselves, thus executing the commands that allow the walker to move toward the source that summoned it. In addition, there is an LED ring, as seen in 21, located around the LiDAR sensor that serves as a visual indicator to the user whether the walker is being summoned, or whether it has a different status: powering up, ready to move, being summoned, folding, low battery, aligning itself, bumped into an obstacle, or experiencing a movement error. The full flowchart of the walker's program operations can be seen in FIG. 13.

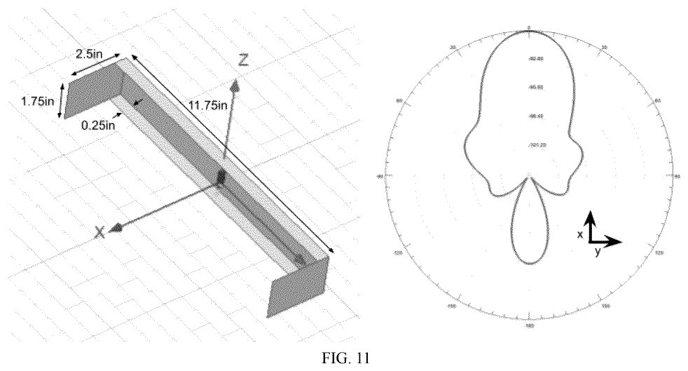

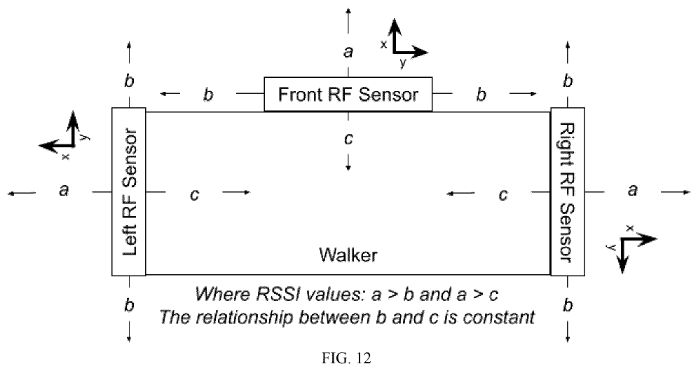

To assist with navigation, multiple long range radio transceivers (7, 19, and 22) are located around the walker. They are all encased in housings formed from a radiation-blocking material, as seen in 23, and specifically in FIG. 11. This serves to allow the walker to determine which direction the user is in by making the sensors pick up directionality. The housings are shaped with specific dimensions which are proportional to the wavelength of the RF beacon, which allows said the beacon's radio waves to have a higher RSSI when the transmission is coming from directly ahead of the RF beacon, and prevent said waves from being detected as strongly from the side or behind the housing unit. The housing also features a lip on the top and bottom of it, increasing the directionality of the unit by further preventing signals from being received if they are transmitted directly behind the unit. This directionality can be seen in the polar coordinate mapping of the relative strength of received signals when rotated around the housing in a simulation. The bold line indicates the relative gain strength at some angle between the exposed front of the housing, with a constant distance. This can be further seen in FIG. 12, showing a simplified top down view of the walker.

It will be apparent to those skilled in the art that changes and modifications may be made in the embodiments illustrated here without changing the overall idea of the invention. Thus, the invention is not to be limited to the exact designs shown and described in this document.

We claim:

1. A technology assisted walker system, comprising; a walker comprising a controller; a motor; one or more wheels; and a wireless communication module; one or more grips; a mechanical folding mechanism; and a locator beacon.

2. The embodiment of claim 1 wherein said motor is configured to cause said wheels to turn when receiving a signal from said controller.

3. The embodiment of claim 1 wherein said locator beacon is a wearable device configured to be worn by a user; wherein said controller is in electronic communication with said locator beacon via said RF communication module; wherein said controller is configured to cause said motor to turn said one or more wheels pursuant to information received regarding a location of said locator beacon, such that said technology assisted walker is brought to within a couple feet of said locator beacon.

4. The embodiment of claim 1 wherein said grips comprise a braking mechanism, wherein brakes are configured to be applied as an inverse to a pressure detected by said one or more grips.
